(19) United States
(12) Patent Application Publication
(10) Pub. No.: US 2009/0109039 A1
(43) Pub. Date: Apr. 30, 2009

(54) REMOTE STARTER SYSTEM WITH TEMPERATURE COMPENSATED CRANK TIME

(76) Inventors: Krikor George Kellzi, Glendale, CA (US); Moti Segal, Northridge, CA (US)

Correspondence Address: LAW OFFICES OF LARRY K. ROBERTS, INC., 2 Park Plaza, Suite 300, Irvine, CA, 92614, US

(21) Appl. No.: 11/923,047

(22) Filed: Oct. 24, 2007

(51) Int. Cl. G08B 17/00

(52) U.S. Cl. 340/584

(57) ABSTRACT

An automated engine starter system is described for a vehicle with an engine and a starter system for starting the engine. A temperature sensor provides an electronic temperature signal indicative of an ambient or engine temperature at the vehicle. A starter controller is responsive to an engine start signal to activate the starter system for a start duration, the starter system being deactivated after expiration of the start duration. The starter controller is responsive to the temperature signal to provide longer start durations for cold temperatures.

### BACKGROUND

Remote starter systems for vehicles are known, in which a vehicle owner may send a command to a remote start system installed in a vehicle to start the vehicle, so that the owner need not be physically present inside the vehicle. This may be useful, for example, in cold climates to warm up the engine and passenger compartment before the driver enters the vehicle. Other applications may utilize a remote start feature to periodically start the engine for battery maintenance, for example, when the vehicle is left parked for an extended time period. The remote starter systems may utilize a wireless remote control, e.g. using an RF link between the remote control and a receiver installed in the vehicle, or a cellular telephone as a remote control.

Remote starter systems, e.g. aftermarket systems, may activate the starter solenoid for a preset amount of time to start the engine. The start time is preset to start the vehicle on the first try. Many systems have a default start time value, e.g. 0.7 second preset. After installing a remote starter system, the installer will try to remote start to see if the engine starts on the first trial; if not the installer programs the start time to an extended or super extended time, which are also preset, e.g. 1 or 1.2 seconds. Since the starter crank time to start a vehicle may vary when the engine temperature is cold or hot, the engine will either fail to start in cold weather or crank too long when the temperature is hot. The result is that installers in climates where the temperature varies widely do not use this type of start feature, and instead may connect an engine RPM input wire to the ignition coil or to one of the fuel injector pulsing wires. Typically, this wire is passed from a controller module inside the vehicle compartment through the fire wall to the engine compartment and is connected to an ignition coil or fuel injector. These connections sometimes become loose and subsequently the remote starter system will fail to start the engine.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a schematic block diagram of an exemplary embodiment of a remote control alarm and keyless entry system with a remote engine starter function.

FIG. 1A is a schematic block diagram of an exemplary embodiment of an automated engine start system.

FIG. 2 is a flow diagram of an exemplary embodiment of an algorithm for compensating a start crank time for an ambient temperature.

FIG. 3 is a flow diagram of an exemplary embodiment of an automated vehicle start algorithm.

### DETAILED DESCRIPTION

In the following detailed description and in the several figures of the drawing, like elements are identified with like reference numerals. The figures are not to scale, and relative feature sizes may be exaggerated for illustrative purposes.

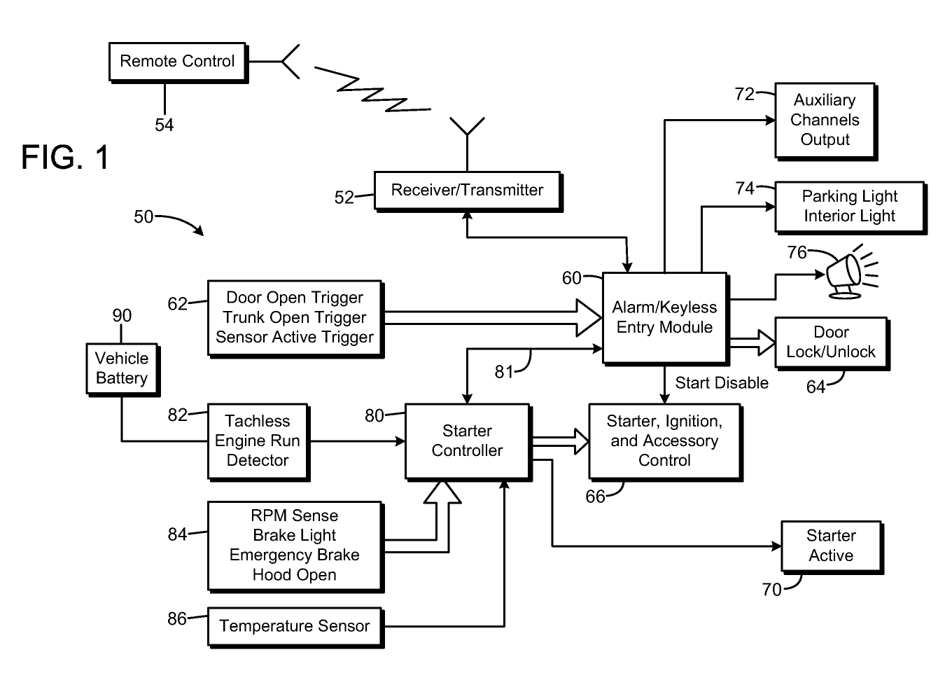

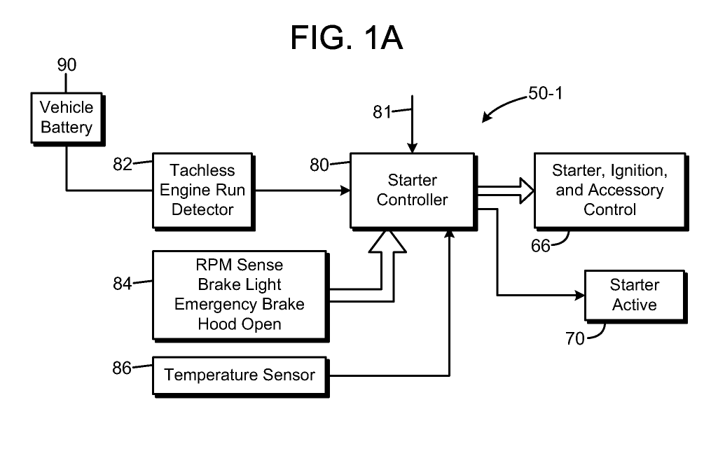

FIG. 1 illustrates in schematic form an exemplary embodiment of a vehicle remote starting system included with a vehicle security and control system 50. The vehicle security and control system includes an alarm/keyless entry control module 60, which typically includes a microprocessor-based controller for controlling alarm, keyless entry and remote starter functions. The system includes a receiver/transmitter 52 for wireless communication with a remote control 54, typically a handheld or keychain type carried by a vehicle user or owner. In other embodiments, the remote control 54 may be a cellular telephone, or a remote computer system communicating with the receiver/transmitter via a wireless internet connection. Typically, the vehicle is equipped with an automatic transmission.

In an exemplary embodiment, the control module 60 receives electronic signals from sensors or trigger (switch) devices 62, such as a door open trigger signal, a trunk open trigger signal and a sensor active trigger signal, e.g. a vibration sensor signal.

The control module 60 may be programmed to execute security algorithms to control various vehicular devices and functions. For example, the user may send a command from the remote control 54 to lock or unlock the vehicle doors, i.e. keyless entry functions. The control module 60 in response sends a signal to the vehicle's power-operated door lock system 64 to lock or unlock the doors. The control module 60 may turn on or off the vehicle parking lights and interior (e.g. dome) light 74 by activating or deactivating relay or solid state switches which connect power to the parking and interior lights. In the event of a detected alarm condition, .e.g. opening a door or hood when the security system is in the armed state, the control module 60, may activate an audible alarm 76 or other alarm function, e.g., disabling the vehicle engine. The control module may also provide a control signal to one or more auxiliary channels 72, e.g. in the event of an alarm condition. For example, the auxiliary channel may be used for a camera, or may activate a GPS tracking system to send a signal through a cellular network to indicate that the car is being tampered with and show the location of the car,

The control module 60 may also provide a vehicle starter disable signal to the starter, vehicle ignition and accessories module 66, which connects the remote starter wire harness to the vehicle starter system, ignition system and accessory controls, e.g. a heater control system.

The system 50 further includes a starter controller 80, which in this exemplary embodiment communicates with the control module 60 through link 81. The control module 60 receives a signal from the receiver/transmitter 52 to start or stop the vehicle and sends that command to the starter controller 80. The controller 80 in turn sends a response back to the control module 60, indicating the running/non-running status of the engine. In the event of an alarm trigger or error shut down signal, e.g. a hood trigger activation, a command to shut the engine off will be sent to the starter controller 80 from the control module 60.

In this exemplary embodiment, the starter controller 80 is connected to an engine run detector 82, which senses the vehicle battery 90 voltage and ripple noise voltage generated by the engine when running. The “tachless” engine run detector 82 determines the engine run condition exclusively from the vehicle battery voltage; the installation does not require that the sensor be connected directly to the battery, any vehicle battery voltage connection will suffice. “Tachless” in this context refers to a detector which determines whether the engine is running inferentially, such as from the battery voltage, and not by a direct connection to the ignition coil or spark plug wire. Information collected from the battery voltage may include a noise and voltage reference, which is processed by a microprocessor algorithm. After the remote starter controller 80 receives a command to start the engine, it first turns the engine ignition on, then measures the battery voltage and noise level signal and stores these measured values as a reference. In an exemplary embodiment, the engine run detector 82 executes an adaptive digital signal processing algorithm to detect reliably when the engine is running, from the vehicle battery voltage and ripple noise voltage. In the “tachless” mode during cranking the engine, the engine run detector 82 is not active. After elapsement of the crank time, the engine run detector is activated to determine if the engine is running; if not the starter controller 80 will try to start the engine for a second, third or successive try.

The starter controller 80 also receives electronic signals 84 indicative of the brake light status, the emergency brake status, the hood open/closed status and from an “RPM sense” circuit. The “RPM” sense circuit typically provides the RPM signal obtained from a direct wire connection to the coil or spark plug, fuel injector, or other signal representing the engine RPM. The open hood trigger indicates that the hood is open; the brake light and emergency brake signals indicate that some one is in the vehicle. In both cases the control module will command the remote starter system to shut the engine down, if occurring during an “armed” mode of the vehicle security system. The RPM sense circuit may be used when the tachless engine run mode is disabled, e.g. during installation of the remote starter system.

The system 50 establishes base line parameters prior to starting the engine and monitors the thresholds after the engine cranking has been completed. The tachless smart sense engine run detector algorithm samples the battery voltage and the ripple prior to engine start. These parameters are used as thresholds after engine crank by the starter controller 80. The starter controller 80 continuously monitors these signals and compares them to the established thresholds. The “Starter active” 70 signal is active during the time that the engine starter is engaged; in an exemplary embodiment, the “Starter active” signal is an active ground. Most new cars have an anti theft device installed and connected to the ignition system to prevent the vehicle engine from being started while the anti-theft device is in an armed state. The “starter active” signal sends a command to a bypass module to override the vehicle's anti theft device, and permit the vehicle engine to be started remotely even while the anti-theft device is in an armed state.

The system 50 further includes a temperature sensor 86 that senses the outside temperature or the engine temperature and provides an electronic signal to the starter controller 80 which is indicative of an ambient outside temperature or an engine temperature; it is preferred to measure an engine temperature such as the engine block temperature. The starter controller 80 is responsive to the temperature sensor signal to adjust the tachless mode start time to compensate for the vehicle start variances resulting from differences in the ambient or engine temperature, so that the engine may be reliably started over a range of temperatures. This allows this type of “tachless” remote start feature, i.e. a feature in which the starter controller does not directly know that the engine has started before disengaging the starter motor, to be used in all climates.

It is noted that FIG. 1 depicts functions of the exemplary embodiment, and is not intended to depict a particular hardware implementation of elements of the system 50. For example, the functions of blocks 60, 80 and 82 may be implemented as separate hardware modules, or may be implemented as a single module or circuit.

In an exemplary embodiment, the starter controller 80 may be programmed to execute an algorithm for compensating or adjusting the start time applied to the starter solenoid by the remote starter system to start the vehicle engine in dependence on the ambient temperature or the vehicle engine temperature.

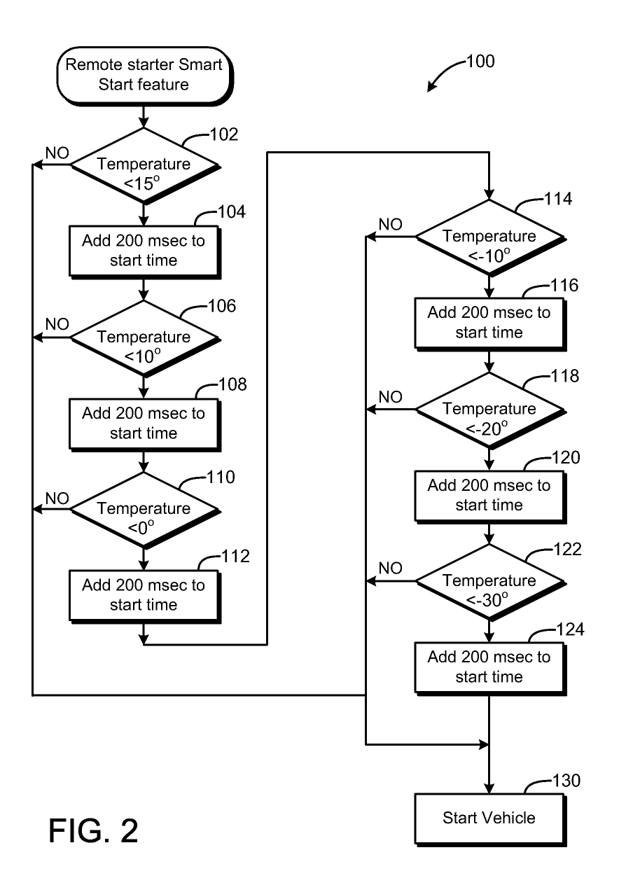

FIG. 2 depicts an exemplary algorithm 100 executed by the starter controller 80. The algorithm may be entered during a remote start procedure, e.g. after receipt of a command sent by the vehicle user using the remote control 54 to the receiver/transmitter 52, and interpreted by the control module 60. The control module, for example, may send a start command to the starter controller 80 via line 81. Upon receipt of the command, the starter controller executes the algorithm 100. The starter controller adjusts a predetermined crank or start time (Tₛ) based on the temperature sensed by sensor 86. An exemplary start time Tₛ, value is 0.8 second, and the adjusted start time can vary up to 4 seconds depending on the temperature of the engine or the ambient temperature. In this exemplary embodiment, the start time is only adjusted if the sensed temperature is below a predetermined threshold value, in this embodiment 15° F. Thus, at 102, if the temperature is not less than this threshold, operation proceeds to 130, the “start vehicle” routine, and the starter controller 80 sends a start command to the starter module 66 to active the vehicle engine starter for the predetermined start time. If the temperature is below 15° F., then a time increment, in this example 200 milliseconds, is added at 104 to the predetermined start time. This incremented start time will be used in the start vehicle routine at 106, 130, if the sensed temperature is not less than 10° F. The start time is incremented by 200 milliseconds again at 108 if the temperature at 106 is less than 10° F. The incremented start time is used at 110, 130 if the temperature is not less than 0° F.

The incrementing process continues for successive tests at 114, 118, and 122, wherein 200 milliseconds are added at 112, 116, 120 and 124. Thus, in this exemplary embodiment, the start time is as follows:
Temperature above 15° F.: Start time=Tₛ
Temperature below 15° F. and above 10° F.: Start time=Tₛ+200 milliseconds
Temperature below 10° F. and above 0° F.: Start time=Tₛ+400 milliseconds
Temperature below 0° F. and above −10° F.: Start time=Tₛ+600 milliseconds
Temperature below −10° F. and above −20° F.: Start time=Tₛ+800 milliseconds
Temperature below −20° F. and above −30° F.: Start time=Tₛ+1 second

These compensation values are exemplary, and other values and temperatures may be employed in other embodiments. The compensation values may, for example, be calculated in real time, or retrieved from a lookup table stored in digital memory.

FIG. depicts an exemplary algorithm 200 for remotely starting a vehicle engine, which may be implemented by a microprocessor based starter controller 80. This algorithm remotes starts a vehicle engine using a temperature compensated crank time, and shuts the engine off after it has run for a set engine run time. The algorithm keeps track of the time duration the engine has run since being started, by use of an engine run timer. The time duration may be a fixed preset duration, or programmed by the user. After a command is received by the starter controller, then the vehicle ignition is turned on at 202, and measurements are taken of the battery voltage and engine noise and stored as references (204). At 206, a temperature sensor is read to determine the ambient temperature or vehicle engine temperature, and a corresponding engine crank time is determined, e.g. by reading from pre-stored values in a lookup table. At 208, the engine starter is cranked for the temperature compensated crank time. After this crank time, the battery voltage is read at 210, and the voltage compared to the reference battery voltage stored at 204. If the battery voltage exceeds the reference voltage, indicating that the engine is running, operation proceeds to 214, to test whether the engine run timer, with a preset run time, has expired. If yes, then at 220, the engine ignition is turned off. If the battery voltage does not exceed the reference at 210, then at 212, the engine noise is measured and compared against the stored engine noise reference value. If the engine noise exceeds the reference value, indicating the engine is running, then operation proceeds to 214. If the noise does not exceed the reference value, operation proceeds to 216. At this stage, the algorithm assumes that the engine has stalled, since the battery voltage and engine noise do not exceed the reference. The engine ignition is turned off and the engine stalled counter is incremented. At 218, if the engine stalled counter exceed 3, then the ignition is turned off at 220. If the counter does not exceed 3, operation returns to 202 to re-attempt engine starting.

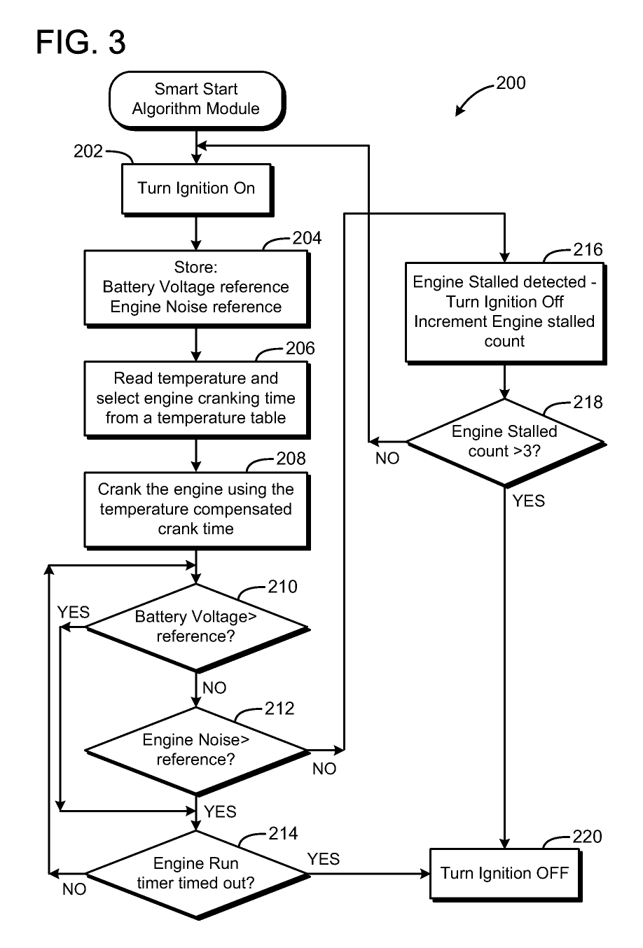

Although the foregoing has been a description and illustration of specific embodiments of the subject matter, various modifications and changes thereto can be made by persons skilled in the art without departing from the scope and spirit of the invention as defined by the following claims. For example, while FIG. 1 depicts a remote starter system incorporated with an alarm/keyless entry system, the starter system may be implemented with a keyless entry system alone, i.e. without an alarm function. In this case the system would omit the alarm siren 76. As a further alternate embodiment, a starter system may be implemented as a stand-alone system or kit which is installed in a vehicle. Such a system is depicted in FIG. 1A as system 50-1. In this embodiment, the starter system is responsive to a command received on line 81 to start the vehicle. This command could be from another system already installed in the vehicle, for example. The system includes the starter controller 80, the tachless engine run detector 82, and the temperature sensor 86 as in the system 50 of FIG. 1. The controller 82 is also responsive to the RPM sense signal as well as the brake light, emergency brake and hood open signals. The system 50-1 when in the tachless mode may operate according to the algorithm 200 of FIG. 3, and applies temperature compensation to the crank time.

What is claimed is:

1. An automated engine starter system for a vehicle with an engine and a starter system for starting the engine, comprising:
a temperature sensor for providing an electronic temperature signal indicative of an ambient temperature at the vehicle;
a starter controller responsive to an engine start signal to activate the starter system for a start duration, the starter system being deactivated after expiration of the start duration, the starter controller further responsive to the temperature signal to provide longer start durations for cold ambient temperatures.

2. The system of claim 1, wherein said starter controller is configured to activate the starter system for a start duration which is fixed for all ambient temperatures above a first predetermined threshold temperature.

3. The system of claim 2, wherein the starter controller is configured to provide start durations of successively incremented duration values for ambient temperature values in a plurality of temperature ranges below said threshold temperature.

4. The system of claim 3, wherein the starter controller is configured to provide a fixed start duration below a second predetermined threshold temperature.

5. The system of claim 4, wherein said first threshold temperature is about 30° F., and said second predetermined threshold temperature is −30° F.

6. The system of claim 1, wherein the ambient temperature is an engine temperature.

7. The system of claim 1, further comprising an engine run detector which when activated provides an electronic engine run signal indicating whether the engine is running, and wherein the starter controller is responsive to said engine run signal after the starter system has been activated for said start duration, and the starter controller is configured to activate the starter system again for said start duration in the event said engine run signal indicates the engine is not running.

8. The system of claim 7, wherein said engine run detector monitors a vehicle battery voltage to determine whether the engine is running.

9. A remote engine starter system for a vehicle with an internal combustion engine and a starter system for starting the engine, comprising:
a vehicle-installed temperature sensor for providing an electronic temperature signal indicative of an ambient temperature at the vehicle;
a portable wireless remote control device;
a vehicle-installed receiver device adapted to receive commands from said portable wireless remote control device, said commands including an engine start command;
a vehicle-installed electronic starter controller responsive to said engine start command to activate the starter system for a start duration, the starter system being deactivated after expiration of the start duration, the starter controller further responsive to the temperature signal to provide longer start durations for cold ambient temperatures.

10. The system of claim 9, wherein said starter controller is configured to activate the starter system for a start duration which is fixed for all ambient temperatures above a first predetermined threshold temperature.

11. The system of claim 10, wherein the starter controller is configured to provide start durations of successively incremented duration values for ambient temperature values in a plurality of temperature ranges below said threshold temperature.

12. The system of claim 11, wherein the starter controller is configured to provide a fixed start duration below a second predetermined threshold temperature.

13. The system of claim 12, wherein said first threshold temperature is about 30° F., and said second predetermined threshold temperature is −30° F.

14. The system of claim 9, wherein the ambient temperature is an engine temperature.

15. The system of claim 9, further comprising an engine run detector which when activated provides an electronic engine run signal indicating whether the engine is running, and wherein the starter controller is responsive to said engine run signal after the starter system has been activated for said start duration, and the starter controller is configured to activate the starter system again for said start duration in the event said engine run signal indicates the engine is not running.

16. The system of claim 15, wherein said engine run detector monitors a vehicle battery voltage to determine whether the engine is running.

17. A vehicle security and control system for a vehicle with an internal combustion engine and a starter system for starting the engine, comprising:
a vehicle-installed temperature sensor for providing an electronic temperature signal indicative of an ambient temperature at the vehicle;
a portable wireless remote control device;
a vehicle-installed receiver device adapted to receive commands from said portable wireless remote control device, said commands including an engine start command;
an electronic control module installed in the vehicle and configured to respond to said commands received by said receiver device, said control module responsive to electronic trigger and sensor signals including a trigger signal generated by a door trigger and adapted to generate a vehicle alarm during an armed state in response to a set of alarm conditions, and to generate a vehicle start command in response to a remote start command received from the remote control device;
a vehicle-installed electronic starter controller responsive to said engine start command to activate the starter system for a start duration, the starter system being deactivated after expiration of the start duration, the starter controller further responsive to the temperature signal to provide longer start durations for cold ambient temperatures.

18. The system of claim 17, wherein the ambient temperature is an engine temperature.

19. The system of claim 17, further comprising an engine run detector which when activated provides an electronic engine run signal indicating whether the engine is running, and wherein the starter controller is responsive to said engine run signal after the starter system has been activated for said start duration, and the starter controller is configured to activate the starter system again for said start duration in the event said engine run signal indicates the engine is not running.

20. The system of claim 19, wherein said engine run detector monitors a vehicle battery voltage to determine whether the engine is running.
